(19) United States
(12) Patent Application Publication
(10) Pub. No.: US 2023/0356331 A1
(43) Pub. Date: Nov. 9, 2023

(54) DEVICE AND METHOD FOR SEPARATING A MATERIAL

(71) Applicant: TRUMPF Laser- und Systemtechnik GmbH, Ditzingen (DE)

(72) Inventors: Daniel Flamm, Ludwigsburg (DE); Jonas Kleiner, Leonberg (DE); Myriam Kaiser, Heimsheim (DE)

(21) Appl. No.: 18/336,031

(22) Filed: Jun. 16, 2023

Related U.S. Application Data
(63) Continuation of application No. PCT/EP2021/080502, filed on Nov. 3, 2021.

(30) Foreign Application Priority Data
Dec. 18, 2020 (DE) 10 2020 134 198.9

(51) Int. Cl. B23K 26/40; B23K 26/0622; B23K 26/38

(52) U.S. Cl. CPC B23K 26/40; B23K 26/0624; B23K 26/38; B23K 2103/54

(57) ABSTRACT

A method for separating a workpiece having a transparent material includes providing ultrashort laser pulses using an ultrashort pulse laser, introducing material modifications into the transparent material of the workpiece along a separation line, and separating the material of the workpiece along the separation line. The laser pulses form a laser beam that is incident onto the workpiece at a work angle. The material modifications are Type III modifications associated with a formation of cracks in the material of the workpiece. The material modifications penetrate two sides of the workpiece that are located in intersecting planes. Separating the material of the workpiece produces a chamfer and/or a bevel. A length of a hypotenuse of the chamfer and/or bevel is between 50 μm and 5000 μm.

### CROSS REFERENCE TO RELATED APPLICATIONS

This application is a continuation of International Application No. PCT/EP2021/080502 (WO 2022/128241 A1), filed on Nov. 3, 2021, and claims benefit to German Patent Application No. DE 10 2020 134 198.9, filed on Dec. 18, 2020. The aforementioned applications are hereby incorporated by reference herein.

### FIELD

Embodiments of the present invention relate to a device and a method for separating a material by means of ultrashort laser pulses.

### BACKGROUND

In recent years, the development of lasers with very short pulse lengths, e.g., with pulse lengths below one nanosecond, and with high mean powers, e.g., in the kilowatt range, has led to a novel type of material machining. The short pulse length and high pulse peak power, or the high pulse energy of a few microjoules to 100 μJ, may lead to nonlinear absorption of the pulse energy within the material, with the result that it is even possible to machine materials that are actually transparent or substantially transparent to the utilized laser light wavelength.

A particular field of application for such laser radiation lies in the separation and machining of workpieces. In the process, the laser beam is preferably introduced into the material with perpendicular incidence as this minimizes reflection losses at the surface of the material. For machining materials at a work angle, for example for facing a material edge or for producing chamfer and/or bevel structures with work angles of more than 30°, this still represents an unsolved problem, also because the large work angles at material edge lead to a significant aberration of the laser beam, with the result that there cannot be a targeted energy deposition in the material.

### SUMMARY

Embodiments of the present invention provide a method for separating a workpiece having a transparent material. The method includes providing ultrashort laser pulses using an ultrashort pulse laser, introducing material modifications into the transparent material of the workpiece along a separation line, and separating the material of the workpiece along the separation line. The laser pulses form a laser beam that is incident onto the workpiece at a work angle. The material modifications are Type III modifications associated with a formation of cracks in the material of the workpiece. The material modifications penetrate two sides of the workpiece that are located in intersecting planes. Separating the material of the workpiece produces a chamfer and/or a bevel. A length of a hypotenuse of the chamfer and/or bevel is between 50 μm and 5000 μm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A, 1B, 1C, 1D, and 1E show a schematic illustration of the method according to some embodiments;

FIGS. 2A, 2B, and 2C show a schematic illustration of chamfer and bevel structures according to some embodiments;

FIGS. 3A, 3B, 3C, 3D, 3E, and 3F show a further schematic illustration of chamfer and bevel structures according to some embodiments;

FIGS. 4A and 4B show schematic illustration of a non-diffractive laser beam according to some embodiments;

FIGS. 5A, 5B, 5C, 5D, and 5E show a further schematic illustration of non-diffractive laser beams according to some embodiments;

FIGS. 6A and 6B show a schematic illustration of the crack formation around a material modification according to some embodiments;

FIGS. 7A and 7B show a schematic illustration of the beam projection onto the material surface according to some embodiments;

FIGS. 8A, 8B, 8C, and 8D show a further schematic illustration of the beam projection onto the material surface according to some embodiments;

FIG. 9 shows a graph for illustrating the transmission as a function of polarization and work angle according to some embodiments;

FIG. 10 shows a schematic illustration of the device for carrying out the method according to some embodiments; and

FIGS. 11A, 11B, and 11C show further schematic illustrations of the device for carrying out the method according to some embodiments.

### DETAILED DESCRIPTION

Embodiments of the present invention provide an improved device for separating a workpiece, and also a corresponding method.

According to some embodiments, a method for separating a workpiece comprising a transparent material is provided, wherein ultrashort laser pulses from an ultrashort pulse laser are used to introduce material modifications into the transparent material of the workpiece along a separation line, and the workpiece is then separated in a separation step along the material modification area that has arisen as a result. According to embodiments of the invention, the laser pulses are brought into the transparent material of the workpiece at a work angle and the material modifications are Type III modifications, which are associated with the formation of cracks in the transparent material.

The ultrashort pulse laser in this case makes ultrashort laser pulses available. In this context, ultrashort may mean that the pulse length is for example between 500 picoseconds and 10 femtoseconds and in particular between 10 picoseconds and 100 femtoseconds. In the process, the ultrashort laser pulses move in the beam propagation direction along the laser beam formed thereby.

When an ultrashort laser pulse is focused into a material of the workpiece, the intensity in the focal volume may lead to nonlinear absorption, for example by multi-photon absorption and/or electron avalanche ionization processes. This nonlinear absorption leads to the generation of an electron-ion plasma, and permanent structural modifications may be induced in the material of the workpiece when the said plasma cools. Since energy can be transported into the volume of the material by way of nonlinear absorption, these structural modifications in the interior of the sample may be produced without the surface of the workpiece being influenced.

In this context, a transparent material is understood to be a material that is substantially transparent at the wavelength of the laser beam from the ultrashort pulse laser. The terms “material” and “transparent material” are used interchangeably herein—which is to say the material specified herein should always be understood to be a material that is transparent to the laser beam of the ultrashort pulse laser.

The material modifications introduced into transparent materials by ultrashort laser pulses are subdivided into three different classes; see K. Itoh et al. “Ultrafast Processes for Bulk Modification of Transparent Materials” MRS Bulletin, vol. 31, p. 620 (2006): Type I is an isotropic refractive index change; Type II is a birefringent refractive index change; and Type III is what is known as a void or cavity. In this respect, the material modification created depends on laser parameters such as the pulse duration, the wavelength, the pulse energy and the repetition frequency of the laser, on the material properties such as, among other things, the electronic structure and the coefficient of thermal expansion, and also on the numerical aperture (NA) of the focusing.

The Type I isotropic refractive index changes are traced back to locally restricted fusing by way of the laser pulses and fast resolidification of the transparent material. For example, quartz glass has a higher density and refractive index of the material if the quartz glass is cooled quickly from a higher temperature. Thus, if the material in the focal volume melts and subsequently cools down quickly, then the quartz glass has a higher refractive index in the regions of the material modification than in the non-modified regions.

The Type II birefringent refractive index changes may arise for example due to interference between the ultrashort laser pulse and the electric field of the plasma generated by the laser pulses. This interference leads to periodic modulations in the electron plasma density, which leads to a birefringent property, which is to say directionally dependent refractive indices, of the transparent material upon solidification. A Type II modification is for example also accompanied by the formation of what are known as nanogratings.

By way of example, the voids (cavities) of the Type III modifications can be produced with a high laser pulse energy. In this context, the formation of the voids is ascribed to an explosion-like expansion of highly excited, vaporized material from the focal volume into the surrounding material. This process is also referred to as a micro-explosion. Since this expansion occurs within the mass of the material, the micro-explosion results in a less dense or hollow core (the void), or a microscopic defect in the sub-micrometre range or in the atomic range, which void or defect is surrounded by a densified material envelope. Stresses which may lead to a spontaneous formation of cracks or which may promote a formation of cracks arise in the transparent material on account of the compaction at the shock front of the micro-explosion.

In particular, the formation of voids may also be accompanied by Type I and Type II modifications. By way of example, Type I and Type II modifications may arise in the less stressed areas around the introduced laser pulses. Accordingly, in the case where a Type III modification is introduced, then a less dense or hollow core or a defect is present in any case. By way of example, it is not a cavity but a region of lower density that is produced in sapphire by the micro-explosion of the Type III modification. On account of the material stresses that arise in the case of a Type III modification, such a modification moreover often is accompanied by, or promotes, a formation of cracks. The formation of Type I and Type II modifications cannot be completely suppressed or avoided when Type III modifications are introduced. Finding “pure” Type III modifications is therefore unlikely.

In the case of high laser repetition rates, the material is unable to cool down completely between the pulses, with the result that cumulative effects of the heat introduced from pulse to pulse may influence the material modification. By way of example, the laser repetition frequency may be higher than the reciprocal of the thermal diffusion time of the material, with the result that heat accumulation as a result of successive absorptions of laser energy may occur in the focal zone until the melting temperature of the material has been reached. Moreover, a region larger than the focal zone can be fused as a result of heat transport of the thermal energy into the areas surrounding the focal zone. The heated material cools quickly following the introduction of the ultrashort laser pulses, and so the density and other structural properties of the high-temperature state are, as it were, frozen in the material.

The material modifications are introduced into the material along a separation line. The separation line describes the line of incidence of the laser beam on the surface of the workpiece. For example, the laser beam and the workpiece are displaced relative to one another at a feed speed as a result of a feed, with the result that the laser pulses are incident on the surface of the workpiece at different locations as time passes. In this context, the feed speed and/or the repetition rate of the laser are chosen so that the material modifications in the material of the workpiece do not overlap but rather are present separate from one another in the material. In this case, displaceable relative to one another means both that the laser beam can be translationally displaced relative to a stationary workpiece and that the workpiece can be displaced relative to the laser beam. There may also be a movement of both the workpiece and the laser beam. The ultrashort pulse laser emits laser pulses into the material of the workpiece at its repetition frequency while the workpiece and laser beam are moved relative to one another.

The material modifications being pronounced in the beam propagation direction results in the creation of an area in the material of the workpiece in which all material modifications are present and which intersects the surface of the workpiece along the separation line. The area in which the material modifications are present is referred to as the material modification area. In particular, the material modification area may also be curved, with the result that material modifications which for example form the lateral surface of a cylinder or cone are also located within a material modification area.

The laser pulses are introduced into the material of the workpiece at what is known as a work angle. In this case, the work angle is given by the angle difference between the laser beam and the surface normal of the workpiece to be separated. When the work angle is not equal to zero, the material modification area is likewise inclined in relation to the surface normal of the workpiece. What needs to be taken into account in this context is that, in the case of a non-vanishing work angle, the laser beam is refracted depending on the respective refractive index of the surrounding medium, preferably air, and of the material of the workpiece, according to Snell's law. As a result, the beam propagation direction in the material of the workpiece may differ from the beam propagation direction prior to entry into the material of the workpiece. In particular, the material modification area may as a result also be tilted at a different angle with respect to the surface normal than the angle of incidence.

In the present case, Type III modifications are used to produce predetermined breaking points in the material, or as it were perforate the material along the material modification area. The crack formation promoted by the voids allows cracks to spread between adjacent material modifications in this case, as will be explained in greater depth hereinafter. Preferably, such crack formation occurs within the material modification area, with the result that the material modification area becomes the separation surface.

The separation along the material modification area is implemented here within the scope of a separation step, with the result that the workpiece is divided into the bulk portion and what is known as the cutting of the workpiece.

In this case, the separation step may comprise a mechanical separation and/or an etching procedure and/or an application of heat and/or a self-separation step.

By way of example, heat may be applied by way of a heating of the material or separation line. By way of example, the separation line may be heated locally by means of a continuous wave CO2 laser, with the result that the material in the material modification region expands differently in comparison with the untreated or unmodified material. However, an application of heat may also be realized by way of a hot air flow, or by baking on a hotplate or by heating the material in an oven. In particular, temperature gradients may also be applied within the scope of the separation step. The cracks promoted by the material modification thereby experience a crack growth, with the result that a continuous and non-catching separation surface may form, by means of which the parts of the workpiece are separated from one another.

A mechanical separation may be generated by the application of a tensile or flexural stress, for example by the application of a mechanical load on the parts of the workpiece separated by the separation line. By way of example, a tensile stress can be applied if opposing forces in the material plane act at a respective point of attack of the force on the parts of the workpiece separated by the separation line, each of the said opposing forces pointing away from the separation line. If the forces are not aligned parallel or antiparallel to one another, then this may contribute to the creation of a flexural stress. The workpiece is separated along the separation surface as soon as the tensile or flexural stresses are greater than the binding forces of the material along the separation surface. In particular, a mechanical change can also be obtained by a pulse-like action on the part to be separated. By way of example, a shock can generate a lattice vibration in the material. Tensile and compressive stresses which may trigger a crack formation can thus likewise be generated by the deflection of lattice atoms.

The material can also be separated by etching using a wet-chemical solution, with the etching process preferably placing the material against the material modification, which is to say the targeted material weakening. The workpiece is separated along the separation surface as a result of the parts of the workpiece weakened by the material modification preferably being etched.

In particular, what is known as self-separation can also be performed by means of a targeted crack progression by way of the orientation of the material modifications in the material. The crack formation from material modification to material modification in this case enables a whole-area separation of the two parts of the workpiece without a further separation step having to be carried out.

This is advantageous in that an ideal separation method can be chosen for the respective material of the workpiece, with the result that separation of the workpiece is accompanied by a high-quality separation edge.

In particular, provision can be made for the material modifications to penetrate two sides of the workpiece which are located in intersecting planes, and for the separation step to produce a shaped edge, preferably a chamfer and/or a bevel.

Two sides are located in intersecting planes if the surface normals of the planes are not aligned parallel to one another. By way of example, in the case of a cuboid, two sides are located in intersecting planes if the sides can be connected by an edge of the cuboid. In the case of a disc-shaped material, the circumferential surface of the disc is, in a certain sense, located in an intersecting plane with the upper side and the lower side of the disc. At least when considered locally, a rectangular cross section arises in the plane of incidence of the laser beam even in the case of a disc.

The material modifications penetrate both adjacent sides. In this case, penetration means that the material modification starts on the one side and, in the beam propagation direction, finishes on the other side. However, it can also mean that the material modification only extends within the material of the workpiece in order to avoid chippings at the surface of the material. However, a larger portion of the path of the laser between the two sides needs to be modified by material modifications in this case. By way of example, as a result of positioning the material modifications in the material in strategically advantageous fashion, it may be sufficient to introduce material modifications along only a third of the path. However, it may also be possible for a material modification to be continuous over the entire path between the two sides.

As a result, a cutting of the workpiece arises in the plane of incidence of the laser beam in which the incident and the refracted beams are located. By way of example, this cutting may be triangular in the case of the cuboid. A triangular cutting of the workpiece has what is known as a hypotenuse, which is opposite the edge to be separated. In this case, the length of the hypotenuse is given by the length of the material modifications within the workpiece. Moreover, the distance of a side adjacent to the hypotenuse of the cutting is given by the distance of the separation line from the edge of the workpiece.

The predetermined breaking point is introduced over the entire hypotenuse length by virtue of the material modifications penetrating two sides of the material. As a result, the workpiece is separated along the material modification area in a subsequent separation step.

Following the separation, the material modification area becomes what is known as the shaped edge of the material. Shaped edges of the workpiece are subdivided into what are known as chamfers and bevels. In this case, a chamfer of the workpiece is understood to be a trim, in the case of which the original edge of the cuboid has been replaced by two edges. As a result, the original edge is defused, or a transition region is created between a first cuboid side and a second cuboid side. By contrast, a bevel is produced if the hypotenuse of the cutting coincides with an edge of the workpiece or, in general, if a side of the triangular cutting corresponds to at least one side length of the workpiece running parallel thereto.

By way of example, the length of the hypotenuse of the chamfer and/or bevel is between 50 μm and 5000 preferably between 100 μm and 200 μm.

This is advantageous in that, as a result, the workpiece can be faced in a manner which is visually appealing and which has a high-quality effect. Moreover, it is consequently also possible to face relatively thick workpieces. Further, the provision of a shaped edge, a chamfer or a bevel allows a more stable edge to be obtained, the latter not chipping off as easily during the installation or in use at the final customer as an edge with a 90° angle.

The laser beam can be a non-diffractive laser beam.

In particular, non-diffractive beams and/or Bessel-type beams should be understood to refer to beams for which a transverse intensity distribution is propagation invariant. In particular, a transverse intensity distribution in a longitudinal direction and/or propagation direction of the beams is substantially constant in the case of non-diffractive beams and/or Bessel-type beams.

A transverse intensity distribution should be understood to mean an intensity distribution located in a plane oriented at right angles to the longitudinal direction and/or propagation direction of the beams. Moreover, the intensity distribution is always understood to mean the part of the intensity distribution of the laser beam which is greater than the modification threshold of the material. By way of example, this may mean that only some of the intensity maxima of the non-diffractive beam or only a few intensity maxima of the non-diffractive beam can introduce a material modification into the material of the workpiece. Accordingly, the phrase “focal zone” can also be used for the intensity distribution, in order to clarify that this part of the intensity distribution is provided in a targeted manner and an intensity boost in the form of an intensity distribution is obtained by focusing.

In respect of the definition and properties of non-refractive beams, reference is made to the following book: “Structured Light Fields: Applications in Optical Trapping, Manipulation and Organisation”, M. Wordemann, Springer Science & Business Media (2012), ISBN 978-3-642-29322-1. Express reference is made to the entire content thereof.

Accordingly, non-diffractive laser beams are advantageous in that they may have an intensity distribution which is elongated in the beam propagation direction, to a significantly greater extent than the transverse dimensions of the intensity distribution. In particular, this renders possible the production of material modifications which are elongated in the beam propagation direction, with the result that these can penetrate two sides of the workpiece easily.

The laser beam may have a non-radially symmetric transverse intensity distribution, with the transverse intensity distribution appearing elongate in the direction of a first axis in comparison with a second axis, and with the second axis being perpendicular to the first axis.

In this case, non-radially symmetric means that the transverse intensity distribution depends not only on the distance to the optical axis but also at least on the polar angle about the beam propagation direction. By way of example, a non-radially symmetric transverse intensity distribution may mean that the transverse intensity distribution is, for example, cruciform or is triangular or is polygonal, for example pentagonal. A non-radially symmetric transverse intensity distribution may also comprise further rotationally symmetric and mirror-symmetric beam cross sections. In particular, a non-radially symmetric transverse intensity distribution may also have an elliptical form, with the ellipse having a major axis A and a minor axis B perpendicular thereto. Accordingly, an elliptical transverse intensity distribution is present if the ratio A/B is greater than 1, in particular if A/B=1.5. The elliptical transverse intensity distribution of the laser beam may correspond to an ideal mathematical ellipse. However, the non-radially symmetric transverse intensity distribution of the non-diffractive laser beam may also merely have the aforementioned ratios of long principal axis and short principal axis, and may have a different contour—for example an approximated mathematical ellipse, a dumbbell-type shape or any other symmetric or asymmetric contour enveloped by a mathematically ideal ellipse.

In particular, elliptical non-diffractive beams can be generated by way of non-diffractive beams. Here, elliptical non-diffractive beams exhibit special properties, which emerge from the analysis of the beam intensity. By way of example, elliptical quasi non-diffractive beams have a principal maximum which coincides with the centre of the beam. The centre of the beam is in this case given by the location at which the principal axes intersect. In particular, elliptical quasi non-diffractive beams may emerge from the superposition of a plurality of intensity maxima, wherein, in this case, only the envelope of the intensity maxima involved is elliptical. In particular, the individual intensity maxima do not have to have an elliptical intensity profile.

As a result of the non-radially symmetric transverse intensity distribution, the material modification in the cross section perpendicular to the beam propagation direction in the material will also likewise be non-radially symmetric. Rather, the shape of the material modification corresponds to the intensity distribution of the non-diffractive beam in the material of the workpiece.

In the case of non-diffractive beams, there are in particular regions of high intensity, which interact with the material and introduce material modifications, and regions below the modification threshold. The non-radially symmetric transverse intensity distribution in this case relates to the intensity maxima above the modification threshold.

Accordingly, the non-radially symmetric Type III material modifications have a preferred direction which runs parallel to the elongated axis of the material modifications. Accordingly, cracks are then typically formed or induced along this preferred direction. By way of example, cracks predominantly spread in the direction of a long axis of an elliptical Type III material modification since the contour of the material modification has a smaller curvature there, and so the stress peaks here preferably relax in the form of a crack in the material.

In particular, it is consequently possible to promote crack progression in a targeted fashion by way of an appropriate orientation of the non-radially symmetric material modifications in the material, and so for example a crack formation is oriented tangentially to the separation line as a result of the orientation of the preferred direction.

By way of example, if the feed direction between the non-diffractive laser beam and the workpiece is parallel to the short axis of the transverse intensity distribution, then it is unlikely for the cracks of adjacent material modifications to meet since the crack formation preferably extends perpendicular to the feed direction. By contrast, if the feed direction is parallel to the long axis in relation to which the crack formation preferably occurs, then it is likely for the cracks of adjacent material modifications to meet and merge. As a result of the orientation of the beam cross section and/or workpiece, it is possible to ensure a targeted crack progression over the entire length of the separation line even in the case of curved separation lines. This makes it possible to separate the material along separation lines of any desired shape.

In the projection of the non-radially symmetric transverse intensity distribution onto the surface of the workpiece, the first axis and the second axis may appear to have the same size as a result of the work angle.

The mathematical projection of the non-radially symmetric transverse intensity distribution onto the surface of the workpiece at the work angle may lead to distortions of the intensity distribution. Thus, for example, a round intensity distribution may be created on the workpiece by an originally elliptical intensity distribution. However, what may in particular also be achieved thereby is that an elliptical projection is realized on the surface of the workpiece by way of an originally round intensity distribution. As a result, material modifications with an intensity distribution which arise from the projection onto the surface of the workpiece at the work angle are introduced into the material.

However, the projection may also result in the distortion of a previously chosen preferred direction of the non-radially symmetric transverse intensity distribution, with the result that the preferred direction deviates from the actually effective intensity distribution.

In an embodiment, it is therefore preferable for the non-radially symmetric transverse intensity distribution to appear round as a result of the work angle. In particular, in the case of an originally elliptical transverse intensity distribution, this means that the major axis A and the minor axis B of the ellipse appear to have the same size as a result of the projection. As a result, it is effectively a round intensity distribution that acts in relation to the production of the material modifications.

The projection of the non-radially symmetric intensity distribution onto the surface of the workpiece can be elongated in the feed direction.

As a result, the distortion by the projection of the intensity distribution onto the surface of the workpiece can be controlled so that the preferred direction of the effective beam profile points in the feed direction. By virtue of the preferred direction pointing in the direction of the feed direction and consequently running parallel to the separation line, it is possible to separate the workpiece easily and with a high quality along the material modification area arising as a result.

The ratio of the first axis to the second axis of the non-radially symmetric transverse intensity distribution can be greater than the reciprocal of the cosine of the work angle.

Assume that a laser beam is incident on a surface at the work angle, with the first axis of the transverse intensity distribution running parallel to the surface of the workpiece and being perpendicular to the plane of incidence of the laser beam and the second axis being in the plane of incidence. Moreover, let the first axis be the long axis and the second axis be the short axis of the non-radially symmetric transverse intensity distribution. Then, the effective length is increased by the factor of the reciprocal of the work angle as a result of the projection of the second axis onto the surface of the workpiece.

By way of example, if the second axis has a length of 10 μm and the work angle is 60°, then the projection of the second axis onto the surface of the workpiece has a length of 10 μm/cos)(60°=20 μm.

Moreover, the first axis of the transverse intensity distribution is not increased by the projection as it is perpendicular to the plane of incidence. Accordingly, the beam profile has a first axis of unchanged size.

If, for example, the first axis in the example above has a length of 20 μm, then it likewise has a length of 20 μm in the projection. However, overall, this hence results in a round beam shape on the surface of the workpiece.

If, for example, the first axis in the example above has a length of 15 μm, then it likewise has a length of 15 μm in the projection, but the second axis has grown to 20 μm. Consequently, material modifications with a preferred direction located in the plane of incidence of the laser beam are produced. In particular, the preferred direction has rotated from the first axis to the second axis as a result of the projection.

Thus, choosing the ratio of the first axis to the second axis to be greater than the reciprocal of the cosine of the work angle ensures that the originally intended alignment of the intensity distribution is maintained even when the beam is projected onto the surface of the workpiece.

The ratio of the first axis to the second axis can be greater than \sqrt{2}.

This ensures that the originally intended alignment of the transverse intensity distribution is maintained, e.g., in the case of a work angle of 45°. In particular, 1/cos(45°=\sqrt{2} applies, with the result that the axes ratio is chosen accordingly. As a result, the preferred direction is maintained by the material modification even when the beam is projected onto the surface of the workpiece.

The material modification area can be inclined at an angle of up to 35° in terms of magnitude, in relation to the surface of the workpiece.

According to Snell's law, the product of refractive index of the surrounding medium and sine of the work angle corresponds to the product of refractive index of the material and sign of the angle of refraction. Accordingly, depending on the refractive indices, the work angle can be chosen so that the material modification area is inclined at no more than 35° with respect to the surface of the workpiece. In particular, the angle specification relates to the material modification area in which the material modifications are located, with the result that this angle directly corresponds to the angle of refraction.

The pulse energy of the laser pulses can be between 10 μJ and 5 μJ and/or the mean laser power can be between 1 W and 1 kW and/or the laser pulses can be individual laser pulses or part of a laser burst and/or the wavelength of the laser can be between 300 nm and 1500 nm, in particular 1030 nm.

This is advantageous in that optimal laser parameters can be provided for various materials.

By way of example, the ultrashort pulse laser may provide individual laser pulses with a pulse energy of 100 μJ, with the mean laser power being 5 W and the wavelength of the laser being 1030 nm.

A laser burst may comprise 2 to 20 laser pulses, with the laser pulses of the laser burst having a temporal spacing of 10 ns to 40 ns, preferably 20 ns.

By way of example, a laser burst may comprise 10 laser pulses and the temporal spacing of the laser pulses may be 20 ns. In this case, the repetition frequency of the laser pulses is 50 MHz. In this case, the laser bursts can be emitted at the repetition frequency of the individual laser pulses which is of the order of 100 kHz.

By using laser burst, it is possible to respond to the material-specific heat properties, with the result that it is possible to produce a shaped edge with a high surface quality.

The incident laser beam may be polarized parallel to the plane of incidence.

The refraction of the laser beam during the transition from the surrounding medium to the material does not only depend on the work angle and the refractive indices. In this case, the polarization of the laser beam also plays an important role. Using the so-called Fresnel equations, it is possible to show that, for an angle of incidence of greater than 10°, the transmission through a material of a laser beam polarized parallel to the plane of incidence is always greater than the transmission of a laser beam polarized perpendicular to the plane of incidence.

In particular, it is thus possible to minimize reflection losses of the laser beam with P-polarization, in order to realize an optimal energy yield for the separation process within the material. Moreover, advantageous energy input coupling into the material can be obtained in the case of an incidence of the laser beam at the Brewster angle.

The object stated above is also achieved by means of a device for separating a workpiece having the features of claim 9. Advantageous developments are evident from the dependent claims, the description and the figures.

Accordingly, a device for separating a workpiece comprising a transparent material is proposed, comprising an ultrashort pulse laser configured to provide ultrashort laser pulses, a processing optical unit configured to introduce the laser pulses into the transparent material of the workpiece, and a feed device configured to move the laser beam made of laser pulses and the workpiece relative to one another with a feed along a separation line and to orient the optical axis of the processing optical unit at a work angle relative to the surface of the workpiece. According to embodiments of the invention, the laser pulses are introduced into the transparent material of the workpiece at a work angle, with the material modifications being Type III modifications, which are associated with the formation of cracks in the material of the workpiece.

By way of example, a processing optical unit can be an optically imaging system. By way of example, a processing optical unit may consist of one or more component parts. By way of example, a component part can be lens or an optically imaging free-form surface or a Fresnel zone plate. By way of the processing optical unit, it is possible to determine, in particular, the depth at which the intensity distribution is introduced into the material of the workpiece. In a sense, this can set the placement of the focal zone in the beam propagation direction. For example, a focal zone can thus be placed onto the surface of the workpiece, or preferably be placed into the material of the workpiece, by adjusting the processing optical unit. By way of example, this allows the focal zone to be set so that the laser beam penetrates through two adjacent sides and consequently leads to the creation of a material modification which, by means of a separation step, allows a whole-area separation of the workpiece.

By way of example, in this case the feed device can be an XY table or an XYZ table, in order to vary the point of incidence of the laser pulses on the workpiece. In this case, the feed device can move the workpiece and/or the laser beam so that the material modifications can be introduced into the material of the workpiece, next to one another along the separation line.

A feed device can likewise have an angle adjustment such that the workpiece and the laser beam can be rotated relative to one another about all Euler angles. This can ensure that the work angle can be maintained along the entire separation line.

In particular, the work angle is also understood to be the angle between the optical axis of the processing optical unit and the surface normal of the workpiece material. In this case, the work angle between the optical axis of the processing optical unit and the surface normal can be between 0 and 60°, for example.

A beam shaping optical unit can shape a non-diffractive laser beam from the laser beam, with the transverse intensity distribution of the non-diffractive laser beam being able to be non-radially symmetric, with the non-radially symmetric transverse intensity distribution being able to be elongate in a first axis in comparison with a second axis, and with the second axis being perpendicular to the first axis.

By way of example, the beam shaping optical unit can be in the form of a diffractive optical element (DOE), a free-form surface in a reflective or refractive embodiment or an axicon or a micro-axicon, or may contain a combination of a plurality of these component parts or functionalities. If the beam shaping optical unit shapes a non-diffractive laser beam from the laser beam upstream of the processing optical unit, then it is possible by way of the focusing of the processing optical unit to determine the depth at which the intensity distribution is introduced into the material. However, the beam shaping optical unit may also be configured in such a way that the non-diffractive laser beam is only generated by way of imaging with the processing optical unit.

A diffractive optical element is configured to influence one or more properties of the incident laser beam in two dimensions. A diffractive optical element is a fixed component which can be used to produce exactly one intensity distribution of a non-diffractive laser beam from the incident laser beam. Typically, a diffractive optical element is a specifically formed diffraction grating, with the incident laser beam being brought into the desired beam shape by the diffraction.

An axicon is a conically ground optical element which shapes a non-diffractive laser beam from an incident Gaussian laser beam as the latter passes through. In particular, the axicon has a cone angle α which is calculated from the beam entrance surface to the lateral surface of the cone. As a result, the marginal rays of the Gaussian laser beam are refracted to a different focal spot than near-axis rays. In particular, this yields an intensity distribution which is elongate in the beam propagation direction.

The processing optical unit may comprise a telescope system configured to introduce the laser beam with a reduced and/or increased size into the material of the workpiece.

An increase or a reduction in the size of the laser beam or in its transverse intensity distribution allows the laser beam intensity to be distributed over a large or small focal zone. As a result of distributing the laser energy over a large or small area, the intensity is adapted such that, in particular, it is also possible to make a choice between modification types I, II and III by way of the increase and/or reduction.

In particular, by increasing or reducing the non-radially symmetric transverse intensity distribution, it is also possible to introduce larger or smaller material modifications into the material of the workpiece. For example, introducing a reduced elliptical transverse intensity distribution into the material is accompanied by a reduction in the radius of curvature of the material modifications introduced thereby. In other words, a given curvature becomes more pointed as a result of a reduction. This can promote a crack formation in the material of the workpiece. Moreover, the optical system can be adapted to match the given machining conditions by way of an increase or a reduction, with the result that the device can be used more flexibly.

The feed device may comprise an axis device and a workpiece holder which are configured to move the processing optical unit and the workpiece relative to one another along three spatial axes in translational fashion and about at least two spatial axes in rotational fashion.

By way of example, an axis device can be a 5-axis device. By way of example, the axis device can also be a robotic arm which guides the laser beam over the workpiece or which moves the workpiece vis-à-vis the laser beam.

As a result of the laser beam and the workpiece being moved relative to one another for the purpose of being able to introduce the material modifications along the separation line, it is necessary for the laser beam or the workpiece to be locally co-rotated in order to maintain the work angle relative to the separation line. As a result, the material modification area may always have the same angle with respect to the surface of the workpiece in the case of curved separation lines.

In particular, such an axis device at the same time also allows a non-radially symmetric transverse intensity distribution to be oriented relative to the separation line, so that material modifications whose preferred directions run parallel to the separation line and which promote a crack formation along the latter are produced.

Moreover, an axis device may also comprise fewer than the 5 movable axes for as long as the workpiece holder is movable about the corresponding number of axes. By way of example, if the axis device is only displaceable in the XYZ-directions, then the workpiece holder may for example have two rotational shafts in order to rotate the workpiece relative to the laser beam.

The beam components of the laser beam can be incident on the workpiece at an angle of incidence of no more than 80° with respect to the surface normal of the workpiece.

As a result of the processing optical unit, the laser pulses converge to the optical axis, which is oriented at the work angle with respect to the surface normal of the workpiece. In this case, the component laser rays of the ray bundle include an angle with respect to the optical axis of the processing optical unit. In particular, these angles may include very large or very small angles as a result of the numerical aperture.

By virtue of these enveloping component laser rays of the laser ray bundle being incident on the surface of the workpiece at an angle of no more than 80°, it is possible to avoid large reflection losses. According to the Fresnel formulas, the reflection and transmission of the laser beam at the surface of the workpiece depends on the angle of incidence and the refractive indices. In the case of grazing incidence of the laser beam, only little laser light can input couple into the material, and so effective material machining ceases. Moreover, the shape of the non-diffractive beam can be negatively influenced as a result.

A polarization optical unit, preferably comprising a polarizer and a waveplate, can be configured to adjust the polarization of the laser beam relative to the plane of incidence of the laser beam, preferably to set the said polarization parallel to the plane of incidence.

A waveplate, such as what is known as a half-wave plate, can rotate the polarization direction of linearly polarized light through a selectable angle. As a result, it is possible to impress a desired polarization on the laser beam.

By way of example, a polarizer can be a thin-film polarizer. The thin-film polarizer only transmits laser radiation with a specific polarization.

Therefore, the polarization state of the laser radiation can always be controlled with a combination of waveplate and polarizer.

A polarization of the laser beam parallel to the plane of incidence is advantageous according to the Fresnel formulas in that, for an angle of incidence of more than 10°, the transmission is always greater than if the laser beam were polarized perpendicular to the plane of incidence. In particular, the transmission in the case of a parallel-polarized laser beam is more constant and uniform over a greater range of angles of incidence than in the case of perpendicular-polarized light. As a result, it is also possible to use a processing optical unit with a large numerical aperture. In the process, there would be an asymmetric beam reflection at the surface of the workpiece in the case of a perpendicular-polarized laser beam, with the result that optical aberrations reduce the quality of the material modifications and hence the quality of the separation surface.

A beam guiding device can be configured to guide the laser beam to the workpiece, the beam guidance being implemented by way of a minor system and/or an optical fibre, preferably a hollow core fibre.

What is known as a free-beam guidance uses a minor system in order to guide the laser beam in various spatial dimensions from a stationary ultrashort pulse laser to the beam shaping optical unit. A free-beam guidance is advantageous in that the entire optical path is accessible, and so for example further elements such as a polarizer and a waveplate can be installed without problems.

A hollow core fibre is a photonic fibre which is able to flexibly transmit the laser beam from the ultrashort pulse laser to the beam shaping optical unit. Adjustment of a mirror optical unit can be dispensed with as a result of the hollow core fibre.

Control electronics can be configured to trigger a laser pulse emission of the ultrashort pulse laser on account of the relative positions of laser beam and workpiece.

A local reduction in the feed speed may be advantageous in the case of curved or polygonal feed trajectories. However, in the case of a constant repetition frequency of the laser, this may lead to the overlap of adjacent material modifications or to unwanted heating and/or fusing of the material. For this reason, control electronics are able to control the pulse emission on the basis of the relative position of laser beam and workpiece.

By way of example, the feed device may comprise a spatially resolving encoder which measures the position of the feed device and laser beam. An appropriate trigger system of the control electronics may trigger the pulse emission of a laser pulse in the ultrashort pulse laser on the basis of the spatial information.

In particular, computer systems may also be used to trigger the pulses. By way of example, the locations of the laser pulse emission may be defined for the respective separation line prior to the machining of the material, with the result that an optimal distribution of the material modifications along the separation line is ensured.

What this achieves is that the spacing of the material modifications is always the same, even if the feed speed varies. In particular, what this also achieves is that it is possible to produce a uniform separation surface, and the chamfer or bevel has a high surface quality.

The workpiece holder may have a surface that does not reflect and/or scatter the laser beam.

In particular, this can prevent the laser beam from being guided back into the material, and causing another material modification there, after it has passed through the material. In particular, a non-reflective and/or non-scattering surface may also increase safety at work.

### Detailed Description of Preferred Exemplary Embodiments

Preferred exemplary embodiments are described below with reference to the figures. In this case, elements that are the same, similar or have the same effect are provided with identical reference designations in the different figures, and a repeated description of these elements is omitted in some instances, in order to avoid redundancies.

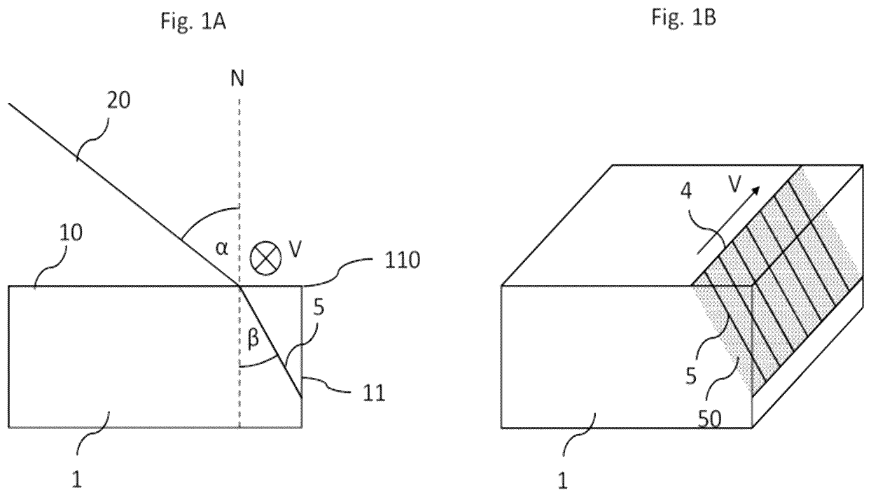

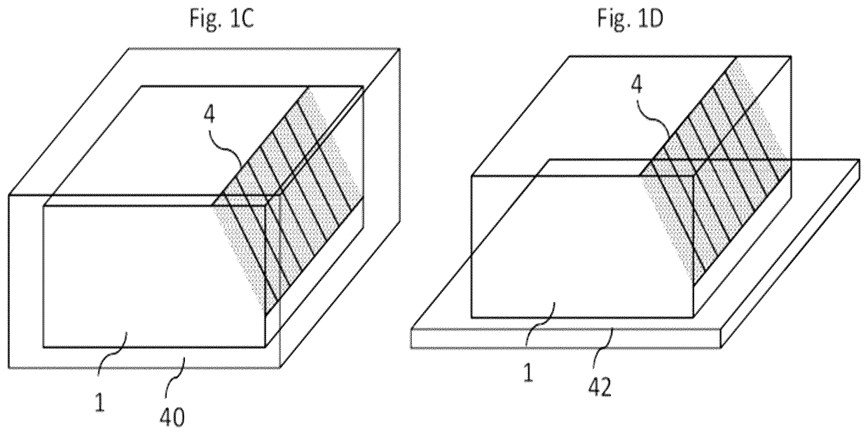

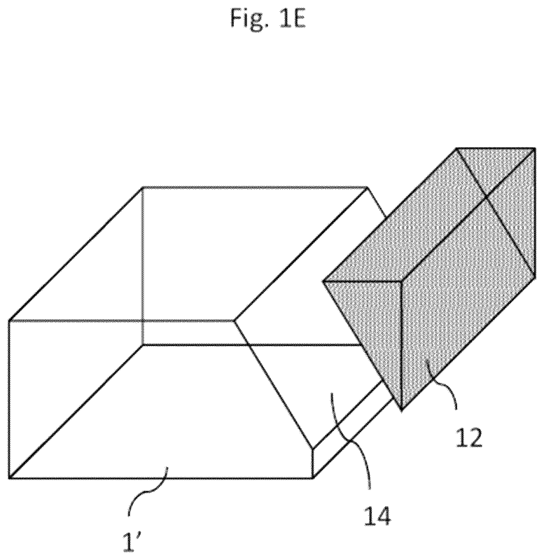

FIG. 1 schematically shows the method for separating a workpiece 1 comprising a transparent material. FIG. 1A shows a cross section of a workpiece 1, on which the laser beam 20 of an ultrashort pulse laser 2 is incident. In this case, the laser beam 20 is introduced onto the workpiece 1 at a work angle α which corresponds to the optical axis of the processing optical unit 3 shown below.

During the transition into the workpiece 1, the laser beam 20 is refracted at the surface 10 of the workpiece 1 according to Snell's law, and so the laser beam 20 continues to propagate in the material of the workpiece 1 at the angle θ with respect to the surface normal N. The material of the workpiece 1 is heated in the focal zone 220 of the laser beam 20 as a result of the introduction of the laser pulses into the workpiece 1 by way of the laser beam 20. In the process, the material of the workpiece 1 is vaporized in the focal zone, and so there is an explosion-like expansion of this plasma state into the surrounding material of the workpiece 1. Material stresses arise at the shock front of this so-called micro-explosion as a result of the compaction there, while a less dense or even empty space (void) remains in the original focal zone 220 of the laser beam. The modification of the material of the workpiece 1 in the focal zone 220 is referred to as material modification 5, with the material modification 5 being a Type III material modification in particular. Ultimately, a crack formation in the material of the workpiece 1 is promoted as a consequence of the material stresses.

In this case, the pulse energy of the laser pulses can be between 10 μJ and 5 μJ and/or the mean laser power can be between 1 W and 1 kW and/or the laser pulses can be individual laser pulses or part of a laser burst and/or the wavelength of the laser can be between 300 nm and 1500 nm. Moreover, it may be the case that a laser burst comprises 2 to 20 laser pulses, with the laser pulses of the laser burst having a temporal spacing of 10 ns to 40 ns, preferably 20 ns.

As shown in FIG. 1B, the laser beam 20 and the workpiece 1 are moved relative to one another with a feed V while the ultrashort pulse laser 2 emits laser pulses. This feed V is guided along a separation line 4 which determines where the workpiece 1 is intended to be separated on the upper side 10. Since the laser beam 20 propagates within the material of the workpiece 1 at the angle β, the material modifications 5 are likewise introduced into the material of the workpiece 1 at the angle β In particular, the material modifications 5 may be shaped differently, in particular elongate in the beam propagation direction, depending on the extent and form of the focal zone 220 or intensity distribution.

In the case of an elongate material modification 5 in the beam propagation direction, what is known as a material modification area 50, within which the material modifications 5 are located, is produced within the material of the workpiece 1 by the simultaneous feed V of the laser beam 20. What should be observed in this context is that the material modifications 5 do not overlap but are present separately from one another. The workpiece 1 is separated into what is known as the bulk workpiece 1′ and into what is known as the cutting 12 by way of the material modification area 50. By way of example, the material modification area 50 can be inclined at an angle β of up to 35° in terms of magnitude, in relation to the surface 10 of the workpiece 1.

In a sense, the material of the workpiece 1 is perforated by the material modifications 5 in the material modification area 50, with the result that the workpiece 1 and the cutting 12 can be separated from one another easily along this material modification area 50.

The actual separation can be realized by specific separation steps. By way of example, a spontaneous crack growth can be initiated by mechanical action on the cutting 12, with the result that the cutting 12 can be separated from the bulk workpiece 1′ over an area.

It may also be the case that the cutting 12 is separated from the bulk workpiece 1′ in a chemical bath, as shown in FIG. 1C. By way of example, it may be the case that the introduced material modifications 5 are susceptible to an etching solution such that the etching procedure in the material modification area 50 separates the cutting 12 from the bulk workpiece 1′.

By way of example, the cutting 12 may also be separated from the bulk workpiece by the action of heat, as shown in FIG. 1D. To this end, the workpiece 1 is heated using a hotplate 42 or heating laser (not shown here), with the result that there is a thermal expansion of the workpiece 1. As a result of the thermal expansion of the workpiece 1, there may be a formation of cracks on account of the material stresses already present in the material modification area 50, with the result that the bulk workpiece 1′ and the cutting 12 are separated from one another over an area.

It may likewise be the case that the workpiece 1 separates on account of the spontaneous formation of cracks and without external influences; this is known as self-separation. The Type III material modifications introduce material stresses into the workpiece 1, and these are already associated with a crack formation per se. Accordingly, the bulk workpiece 1 and the cutting 12 can already be separated by way of this spontaneous crack formation as well.

What is known as a chamfer and/or a bevel, as shown in FIG. 1E, is created on the bulk workpiece 1′ as a result of the above-described separation step. Trimming the workpiece 1 as a shaped edge of the workpiece 1 is likewise known. The chamfer or bevel is formed by the material modification area 50 such that the angle of refraction β arises from the work angle α of the laser beam 20, the refractive index of the surrounding medium and the refractive index of the workpiece 1, and hence such that the alignment of the material modifications 5 and ultimately of the chamfer or bevel likewise arises.

To produce a shaped edge 14, it is advantageous for the material modifications 5 to penetrate those sides of the workpiece 1 which form the edge that should be faced. By way of example, the sides 10 and 11 in FIG. 1A form the edge 110 that should be faced. In particular, the sides 10 and 11 of the workpiece 1 are located in intersecting spatial planes, with the line of intersection of the planes precisely being the edge 110 of the workpiece 1.

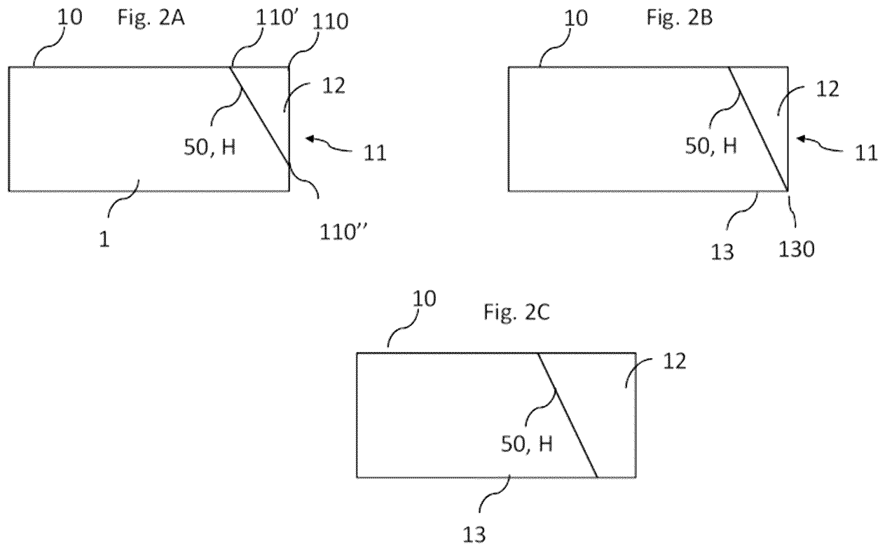

FIGS. 2A to 2C show different possible shaped edges of the material. The material modification area 50 intersects the workpiece 1 in FIG. 2A, with the height of the chamfer being smaller than the height of the side 11 and the width of the chamfer being less than the side 10. Accordingly, the edge 110 is replaced by two edges 110′ and 110″ as a result of the facing. In particular, the original edge 110 is made blunt, or flattened, as a result.

In FIG. 2B, the material modification area 50 intersects the workpiece 1, with the height of the cutting 12 corresponding to the height of the side 11 and the material modification area 50 and the edge 130 formed by the lower side 13 of the workpiece 1 and the side 11 coinciding. The number of edges remains constant in this example, but the angle at which the sides 13 and 11 meet becomes more pointed. Accordingly, the workpiece 1 can be sharpened and/or brought a point by shaping a bevel 12.

In FIG. 2C, the material modification area 50 intersects the workpiece 1, with the material modification area intersecting both the upper side 10 and the lower side 13 of the workpiece 1. As a result, the longitudinal extent of the workpiece 1 overall is reduced and the workpiece 1 is likewise sharpened, as shown in FIG. 2B.

In each case shown, what is known as the hypotenuse H of the cutting 12 is given by the length of the material modifications in the material.

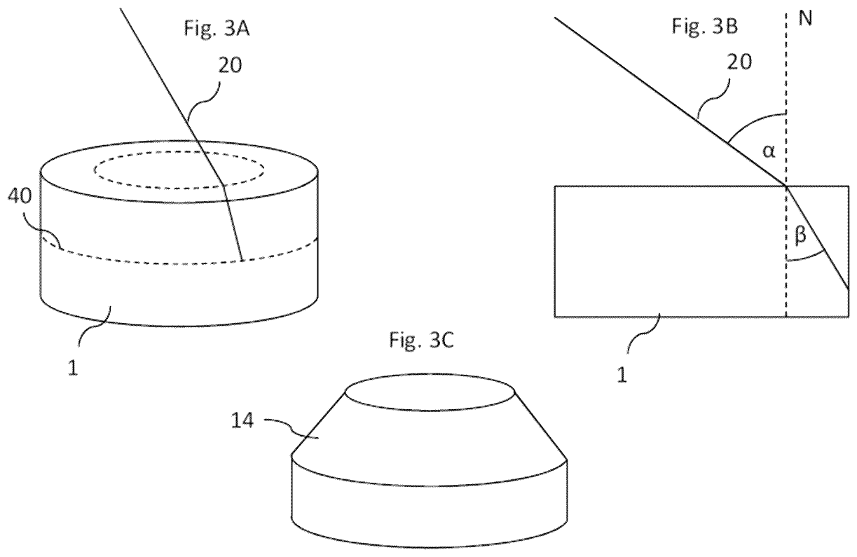

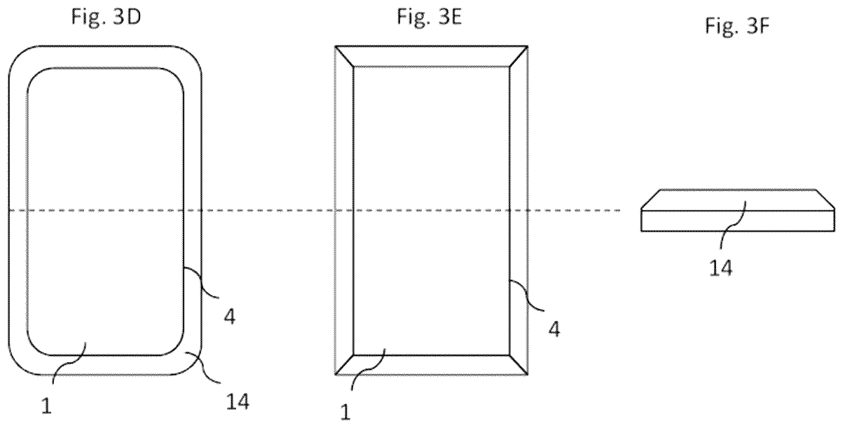

Even if the description to this point has been reduced to the separation of cuboids, round materials 1 or rounded-off materials can also be separated by way of the method. By way of example, FIGS. 3A, B show a workpiece 1 in the form of a disc. What is known as the plane of incidence is defined by the laser beam 20 incident at the work angle α and by the laser beam 20 refracted at the angle β. Within this plane of incidence, the above description can be adopted word for word.

FIG. 3C moreover shows that facing the disc from FIGS. 3A, B leads to a conically tapering element, with result that the introduced material modifications 5 render it possible to produce very different forms of shaped edges.

A further example is shown in FIG. 3D. Material modifications 5 were introduced into the workpiece 1 all round, with the separation line 4 being curved and the work angle α in the plane of incidence always being kept constant. As a result, a rounded-off chamfer or bevel with a high optical quality arises after the separation step.

A further example is shown in FIG. 3E. In contrast with FIG. 3D, no rounded-off separation line 4 was used in this case. The workpiece 1 was successively faced on all four sides, with the result that a crystal-shaped chamfer arises at the corners of the workpiece 1 following the separation step. Consequently, the method is also suitable for giving the workpiece 1 a high-quality appearance.

FIG. 3F shows the cross section of the materials 1 from FIGS. 3D and 3F. The cross section clearly shows the formation of a chamfer 14.

What are known as non-diffractive laser beams 20 are suitable for producing simple material modifications 5, which penetrate the workpiece 1 at least in sections. Non-diffractive beams 20 preferably have an elongate focal zone 220 of length L in the beam propagation direction. The workpiece 1 can be faced easily and effectively by virtue of the length L of the focal zone 220 being greater than the length of the desired hypotenuse H of the cutting 12.

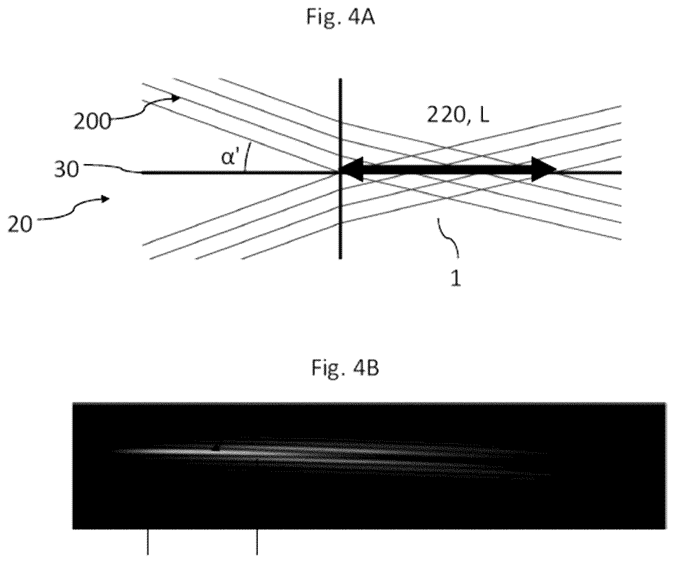

FIG. 4A schematically shows a laser beam 20 processed by a beam shaping optical unit. The component laser rays 200 of the laser beam 20 are incident on the workpiece 1 at an angle α′ with respect to the optical axis 30, with each component laser ray 200 being refracted in accordance with its angle α′ with respect to the optical axis 30. However, overall, the optical axis 30 in this example of the laser beam 20 is perpendicular to the surface 10 of the workpiece 1, with the result that the work angle is 0°. In the workpiece 1, the component laser rays 200 superpose to form a non-diffractive beam with an elongate focal zone 220 of length L.

Aberrations arise in the material in the case of an oblique incidence of the laser beam 20, which is to say in the case of a non-vanishing work angle α, since the upper beam half is incident on the workpiece 1 at an angle α+α′ and the lower beam half is incident on it at the angle α-α′. As a result, the focal zone 220 may shorten or become distorted, as shown in FIG. 4B for a work angle of α=15°. However, material modifications 5 can be produced within the scope of the method even when a laser beam without aberration correction is used, with the hypotenuse H of the chamfer and/or bevel being between 50 μm and 5000 μm, preferably between 100 μm and 200 μm.

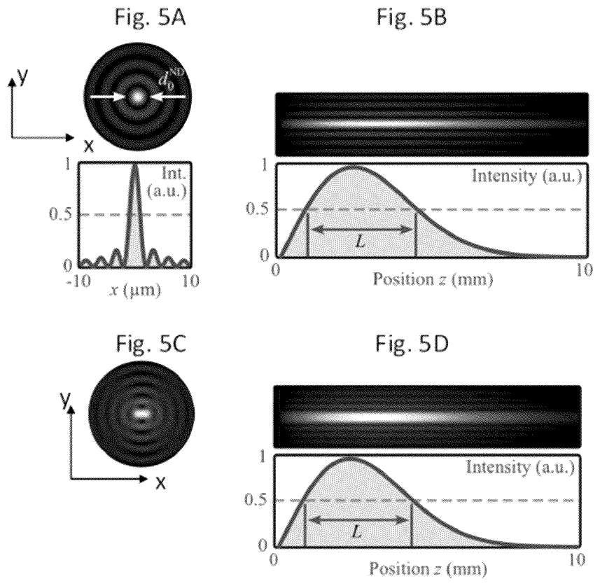

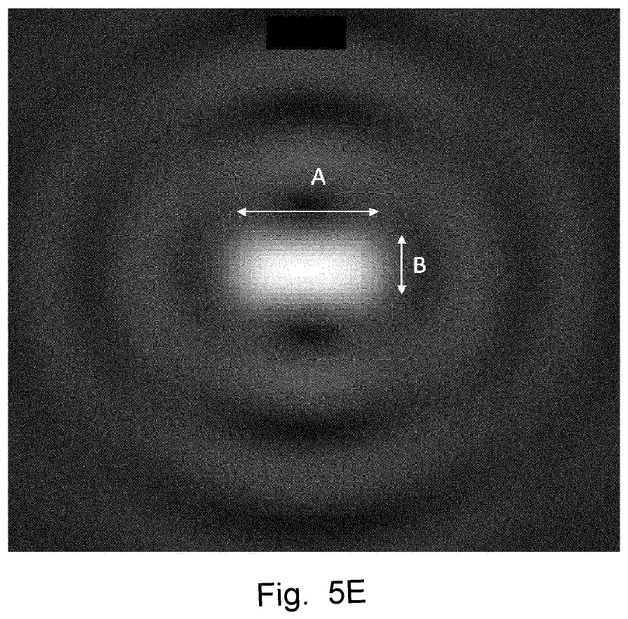

FIG. 5A shows the transverse intensity distribution or the focal zone 220 of a non-diffractive laser beam 20. The non-diffractive laser beam 20 is what is known as a Bessel-Gauss beam, with the transverse intensity distribution in the xy plane being radially symmetric, and so the intensity of the non-diffractive laser beam 20 only depends on the radial distance from the optical axis 30. In particular, the diameter of the transverse intensity distribution is between 0.25 μm and 10 μm. FIG. 5B shows the longitudinal beam cross section, which is to say the longitudinal intensity distribution. The longitudinal intensity distribution has an elongate region of high intensity, with a size of approximately 3 mm. Hence, the longitudinal extent of the focal zone 220 is significantly greater than the transverse extent.

In a manner analogous to FIG. 5A, FIG. 5C shows a non-diffractive laser beam which has a non-radially symmetric transverse intensity distribution. In particular, the transverse intensity distribution appears to be stretched in the y-direction and virtually elliptical. FIG. 5D shows the longitudinal intensity distribution of the laser beam 20, with the focal zone 220 again having an extent of L=3 mm. FIG. 5E shows a magnified portion of the transverse intensity distribution from FIG. 5C, with the various intensity maxima arising by the superposition of the various component laser rays 200. In particular, the focal zone 220 has been significantly elongated in the horizontal direction A vis-à-vis the vertical direction B, with the two directions being perpendicular to one another.

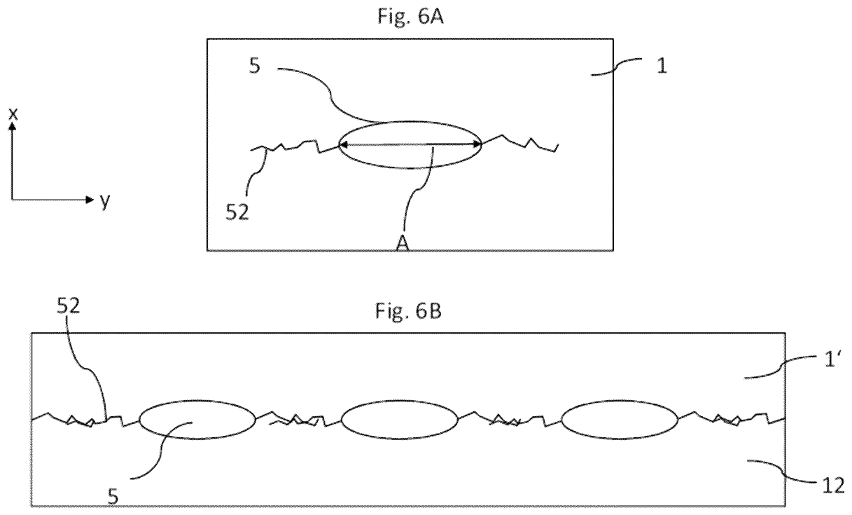

If a laser beam 20 with such a focal zone 220 is introduced into the workpiece 1, then the material modification 5 arising as a result has the same form. This is shown in FIG. 6A. In particular, the material modification 5 has a pointed side and a flat side as a result, with the pointed sides being found in the direction of the long axis A and the blunt sides being found in the direction of the short axis B. In this case, a crack formation 52 as a result of the material modification 5 is obtained in the direction of the long axis A since the stress peaks are greatest there.

Accordingly, it is preferable for the long axis A of the non-radially symmetric transverse intensity distribution to be oriented along the separation line 4, for example to be oriented tangentially with respect to the separation line 4, so that the induced crack formation follows the separation line 4. If the material modifications 5 are now oriented by the separation line 4 such that the cracks 52 of adjacent material modifications 5 overlap, as in FIG. 6B, then the separation by the separation step can be implemented easily.

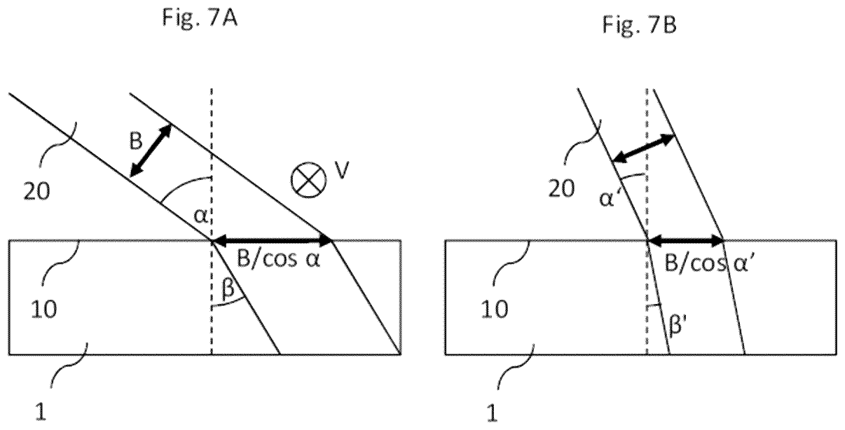

If a laser beam 20 with a round or a non-radially symmetric transverse intensity distribution is projected onto a surface 10 of the workpiece 1 at a work angle α, then this results in a distortion of the intensity distribution in the plane of incidence. This is shown in FIG. 7. In FIGS. 7A, B, the laser beam 20 is incident on the surface 10 of the workpiece 1 with a non-radially symmetric transverse intensity distribution. By way of example, the short axis B can lie in the plane of incidence while the long axis A of the beam profile is parallel to the feed direction V. What this can achieve is that the crack formation 52 will preferably extend in the feed direction 2. However, as a result of projecting the short axis B onto the surface 10, the intensity of the short axis B is distributed over the length B/cos a, and so the short axis B becomes longer with increasing work angle as a result of the projection. In particular, it is possible as a result to obtain the case where the projection of the short axis B corresponds to the length of the long axis A. In that case, the produced material modification 5 no longer has a preferred direction for the crack formation.

By way of example, the short axis grows to \sqrt{2}B in the case of a work angle of 45°. Therefore, if the ratio A/B prior to the projection is greater than \sqrt{2}, then the orientation of the long axis A relative to the separation line 4 is maintained in the projection.

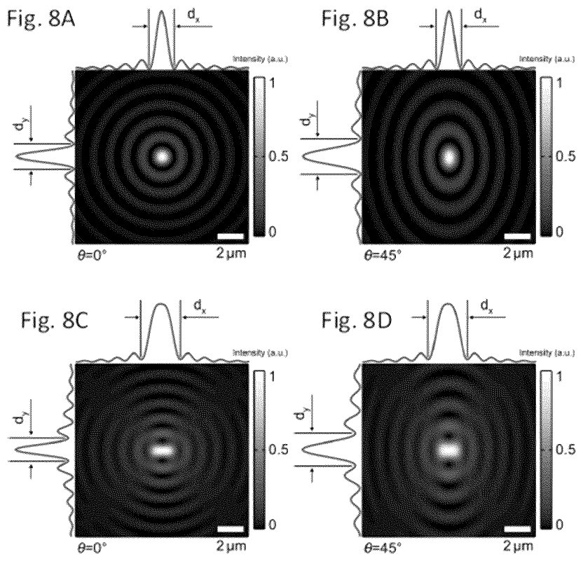

FIG. 8 shows further examples in respect of the influence of the projection. FIG. 8A shows a Bessel-Gauss beam from FIG. 5A in the case of perpendicular incidence on the surface 10 of the workpiece 1. In the case of a non-vanishing work angle α, as shown in FIG. 8B, the radially symmetric intensity distribution on the surface 10 of the workpiece 1 becomes an intensity distribution that is elongate in one direction, with the result that the material modifications 5 arising as a result have a preferred direction. Accordingly, a preferred direction of the material modification 5 can be set or adjusted by the projection of the laser beam 20 onto the surface 10 of the workpiece 1. FIG. 8C shows the Bessel beam from FIG. 5C. The alignment of the long axis A is maintained by the projection onto the surface 10 of the workpiece 1, with the result that there is no change in the orientation of the preferred direction of the crack propagation of the material modification 5 arising as a result. In this case, A/B is smaller than the reciprocal of the cosine of the work angle α.

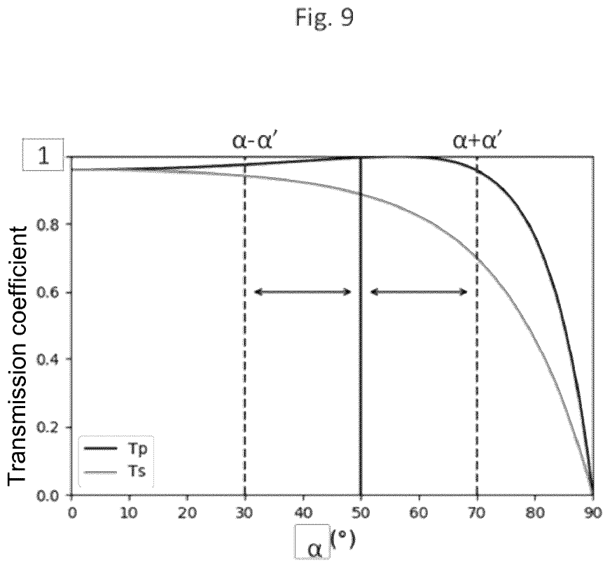

In particular, the laser beam 20 can be polarized, preferably be polarized parallel to the plane of incidence, in order to minimize reflection losses. In this respect, FIG. 9 depicts the transmission of laser radiation through a workpiece 1 in the case of parallel and perpendicular polarization with respect to the plane of incidence, as per the Fresnel formulas. In particular, the work angle α is plotted along the X-axis, but the component laser rays 20 according to FIG. 4A have a convergence angle α′ relative to the optical axis 30.

By way of example, in the case of a work angle α=50° and a convergence angle of α′=20°, the component laser rays 200 are incident on the surface 10 of the workpiece 1 in an angular range from α-α′=30° to α+α′=70°. As a result, the transmission in the case of parallel incidence ranges between 96% and 94% while it varies between 95% and 70% in the case of perpendicular incidence. Accordingly, the variation for laser beams 20 polarized perpendicular to the plane of incidence is significantly more pronounced than that for light polarized parallel to the plane of incidence. Therefore, for the purpose of reducing reflection losses, it is advantageous for the component laser rays 200 to be incident on the workpiece 1 at an angle of less than 80° with respect to the surface normal N.

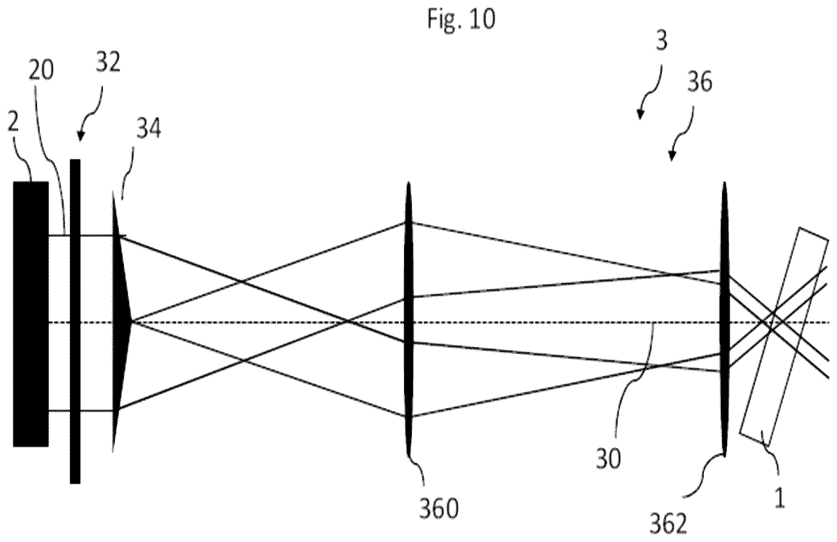

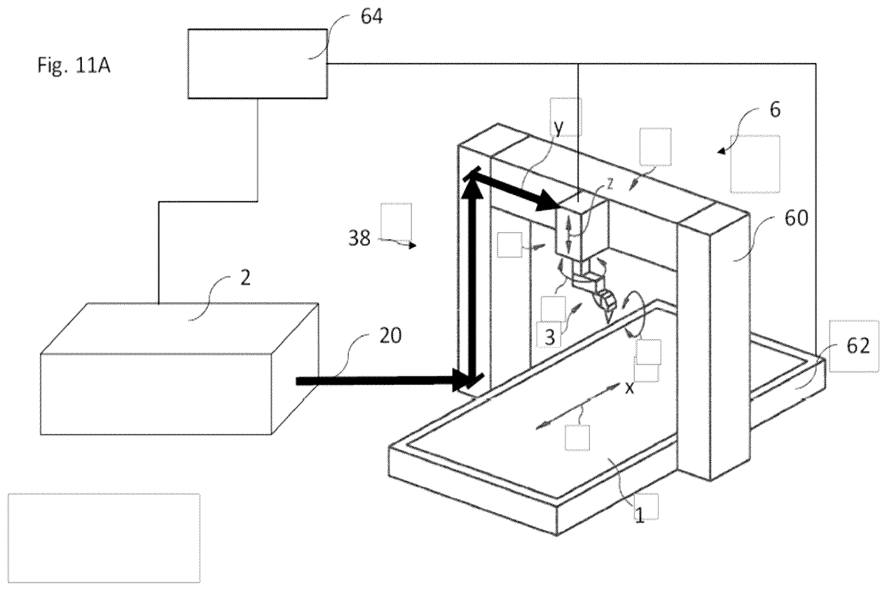

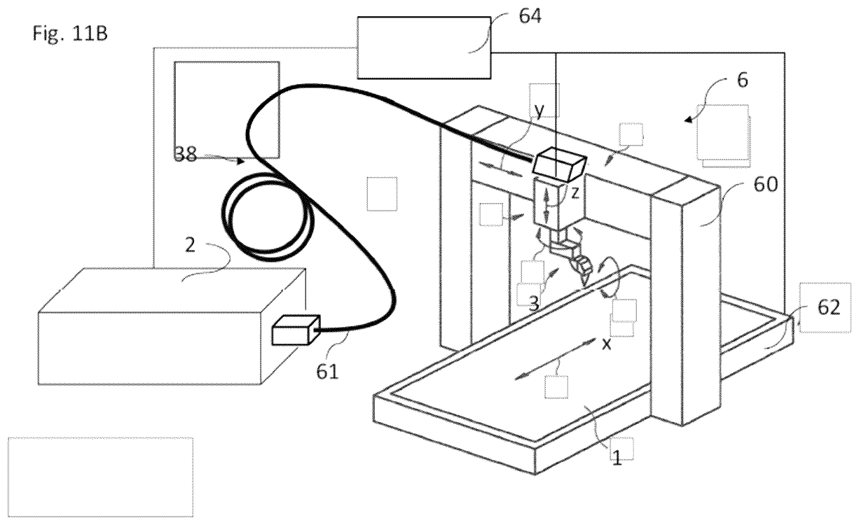

FIG. 10 shows an embodiment of the device for carrying out the method. In this case, the laser pulses are provided by the ultrashort pulse laser 2 and steered through a polarization optical unit 32 through a beam shaping optical unit 34. From the beam shaping optical unit 34, the laser beam 20 is steered onto the workpiece 1 through a telescope system 36, with the optical axis 30 of the processing optical unit 3 being oriented at the work angle α with respect to the surface normal N of the workpiece 1.

In this case, the polarization optical unit 32 may comprise a polarizer which polarizes the laser beam 20 emitted by the ultrashort pulse laser 2 such that the said laser beam only has a well-defined polarization. Then, a subsequent half-wave plate can ultimately rotate the polarization of the laser beam 20 such that the laser beam 20 can be introduced into the workpiece 1 with a polarization preferably parallel to the plane of incidence.

In the example shown, the beam shaping optical unit 34 is an axicon for shaping the incident laser beam 20 into a non-diffractive laser beam. However, the axicon may also be replaced by other elements for the purpose of generating a non-diffractive beam. The axicon generates a conically tapering laser beam 20 from the preferably collimated input beam. In this context, the beam shaping optical unit 34 may also impress a non-radially symmetric intensity distribution on the incident laser beam 20. Finally, the laser beam 20 can be imaged into the workpiece 1 via a telescope optical unit 36, which consists of two lenses 360, 362 here, with the imaging being able to be a magnifying or a reducing imaging. A part of the telescope optical unit 36, in particular the lens 360, may also be integrated into the beam shaping optical unit 34. By way of example, a refractive free-form surface or an axicon with a spherically polished back side may have both the lens function of the lens 360 and the beam shaping function of the beam shaping optical unit 34.

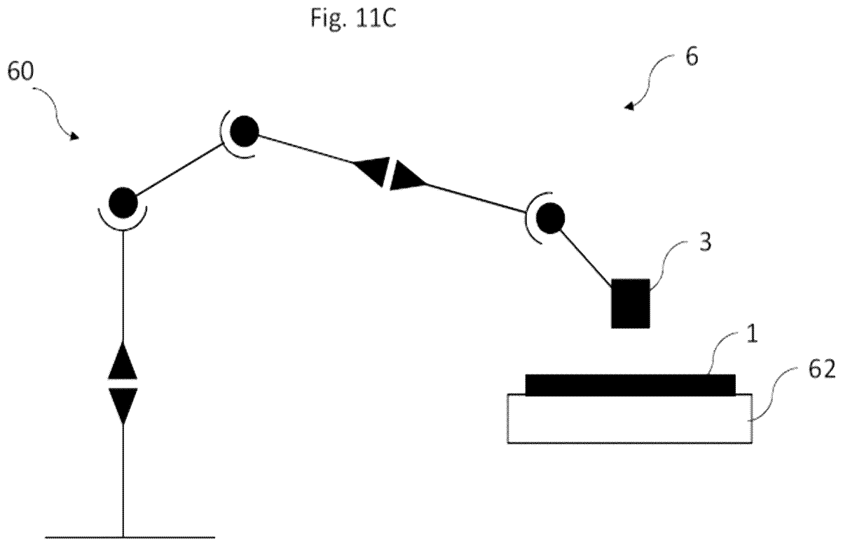

FIG. 11A shows a feed device 6 configured to move the processing optical unit 3 and the workpiece 1 in translational fashion along three spatial axes and in rotational fashion about two spatial axes. The laser beam 20 of the ultrashort pulse laser 2 is steered onto the workpiece 1 by a processing optical unit 3. In this case, the workpiece 1 is arranged on a supporting surface of the feed device 6, with the supporting surface preferably neither absorbing nor reflecting the laser energy which was not absorbed by the material, nor significantly scattering the said laser energy back into the workpiece 1.

In particular, the laser beam 20 can be input coupled into the processing optical unit 3 by way of a beam guiding device 38. In this case, the beam guiding device may be a free-space path with a lens and mirror system, as shown in FIG. 11A. However, the beam guiding device 38 may also be a hollow core fibre with an input coupling and output coupling optical unit, as shown in FIG. 11B.

In the present example of FIG. 11A, the laser beam 20 is steered in the direction of the workpiece 1 by a mirror structure and introduced into the workpiece 1 by the processing optical unit 3. The laser beam 20 causes material modifications 5 in the workpiece 1. The processing optical unit 3 can be moved and adjusted relative to the material by means of the feed device 6, for example such that a preferred direction or an axis of symmetry of the transverse intensity distribution of the laser beam 20 can be adapted to the feed trajectory, and hence to the separation line 4.

In this case, the feed device 6 can move the workpiece 1 under the laser beam 20 with a feed V such that the laser beam 20 introduces material modifications 5 along the desired separation line 4. In particular, in the shown FIG. 11A, the feed device 6 comprises a first axis system 60, by means of which the workpiece 1 can be moved along the XYZ-axes and can optionally be rotated. In particular, the feed device 6 may also comprise a workpiece holder 62 which is configured to hold the workpiece 1. Optionally, the workpiece holder may likewise have degrees of freedom of movement such that the long axis of a non-radially symmetric transverse intensity distribution perpendicular to the beam propagation direction can always be oriented tangentially with respect to the separation line 4.

For this purpose, the feed device 6 may also be connected to control electronics 64, the control electronics 64 converting the user commands of a user of the device into control commands for the feed device 6. In particular, predefined cutting patterns may be stored in a memory of the control electronics 64 and the processes may be automatically controlled by the control electronics 64.

The control electronics 64 may in particular also be connected to the ultrashort pulse laser 2. In this context, the control electronics 64 may demand or trigger the emission of a laser pulse or a laser pulse train. The control electronics 64 may also be connected to other specified components and may thus coordinate the material machining.

In particular, a position-controlled pulse trigger can be realized in this way, with for example an axis encoder 600 of the feed device 6 being read out and the axis encoder signal being interpreted as a location specification by the control electronics 64. Consequently, it is possible that the control electronics 64 automatically trigger the emission of a laser pulse or laser pulse train, for example if an internal adder unit, which adds the traversed path length, reaches a value and resets to 0 after this value has been reached. Thus, for example, a laser pulse or laser pulse train can be automatically emitted into the workpiece 1 at regular intervals.

By virtue of it being possible to also process the feed speed V and the feed direction, and hence the separation line 4, in the control electronics 64, there can be an automated emission of the laser pulses or laser pulse trains.

The control electronics 64 are also able to calculate, on the basis of the measured speed and the fundamental frequency provided by the laser 2, a distance or a location at which a laser pulse train or laser pulse should be emitted. In particular, what can be achieved as a result is that the material modifications 5 do not overlap in the workpiece 1.

By virtue of the emission of the laser pulses or the pulse trains being implemented under position control, complicated programming of the separation process can be dispensed with. Moreover, freely selectable process speeds can be implemented easily.

FIG. 11C likewise shows a feed device 6 in which the processing optical unit is guided over the workpiece 1 by way of a 5-axis arm for the purpose of introducing material modifications 5 into the workpiece 1. The combination of rotational arms allows the processing optical unit to be displaced along three spatial axes and rotated about two spatial axes.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Workpiece
1′ Bulk workpiece
10 Surface
11 Upper side
110 Edge
12 Cutting
13 Lower side
130 Edge
14 Shaped edge, chamfer, bevel
2 Ultrashort pulse laser
20 Laser beam
200 Component laser ray
220 Focal zone
3 Processing optical unit
30 Optical axis
32 Polarization optical unit
34 Beam shaping optical unit
36 Telescope
38 Beam guiding device
360 First lens
362 Second lens
4 Separation line
40 Chemical bath
42 Hotplate
5 Material modification
50 Material modification area
52 Cracks
6 Feed device
60 Axis device
62 Workpiece holder
64 Control electronics
α Work angle
β Angle of refraction
A First axis
B Second axis
N Surface normal
V Feed
H Hypotenuse

1. A method for separating a workpiece having a transparent material, the method comprising:
providing ultrashort laser pulses using an ultrashort pulse laser,
introducing material modifications into the transparent material of the workpiece along a separation line, and
separating the material of the workpiece along the separation line, wherein the laser pulses form a laser beam that is incident onto the workpiece at a work angle, the material modifications are Type III modifications associated with a formation of cracks in the material of the workpiece, the material modifications penetrate two sides of the workpiece that are located in intersecting planes, separating the material of the workpiece produces a chamfer and/or a bevel, and a length of a hypotenuse of the chamfer and/or bevel is between 50 μm and 5000 μm.

2. The method according to claim 1, wherein separating the material of the workpiece comprises a mechanical separation, and/or an etching procedure, and/or an application of heat, and/or a self-separation.

3. The method according to claim 1, wherein
the laser beam is a non-diffractive laser beam, and/or
the laser beam has a non-radially symmetric transverse intensity distribution, with the transverse intensity distribution appearing elongate in a direction of a first axis in comparison with a second axis perpendicular to the first axis.

4. The device according to claim 3, wherein
a projection of the non-radially symmetric transverse intensity distribution onto the workpiece appears to have a same size along the first axis and along the second axis as a result of the work angle, and/or
the projection of the non-radially symmetric transverse intensity distribution onto the workpiece is elongated in a feed direction, and/or
a ratio of the first axis to the second axis of the non-radially symmetric transverse intensity distribution is greater than a reciprocal of cosine of the work angle, and/or
the ratio of the first axis to the second axis is greater than \sqrt{2}.

5. The method according to claim 1, wherein the length of the hypotenuse of the chamfer and/or bevel is between 100 μm and 200 μm.

6. The method according to claim 1, wherein:
a pulse energy of the laser pulses is between 10 μJ and 5 μJ, and/or
a mean laser power is between 1 W and 1 kW, and/or
the laser pulses are individual laser pulses or part of a laser burst, a laser burst comprising 2 to 20 laser pulses, and the laser pulses of the laser burst having a temporal spacing of 10 ns to 40 ns, and/or
a wavelength of the laser [I;ses is between 300 nm and 1500 nm.

7. The method according to claim 1, wherein the laser beam is polarized parallel to a plane of incidence.

8. A device for separating a workpiece comprising a transparent material, the device comprising:
an ultrashort pulse laser configured to provide ultrashort laser pulses,
a processing optical unit configured to introduce the laser pulses into the material of the workpiece, and
a feed device configured to move the laser beam formed by the laser pulses and the workpiece relative to one another with a feed along a separation line, and to orient an optical axis of the processing optical unit at a work angle relative to a surface of the workpiece, wherein the laser pulses are introduced into the workpiece at the work angle, material modifications are introduced in the material of the workpiece by the laser pulses, the material modifications are Type III modifications associated with a formation of cracks in the material of the workpiece, the material modifications penetrate two sides of the workpiece that are located in intersecting planes, a separation step separating the material of the workpiece produces a chamfer and/or a bevel, a length of a hypotenuse of the chamfer and/or bevel is between 50 μm and 5000 μm.

9. The device according to claim 8, further comprising a beam shaping optical unit configured to shape the laser beam into a non-diffractive laser beam, with a transverse intensity distribution of the non-diffractive laser beam being non-radially symmetric, with the non-radially symmetric transverse intensity distribution being elongate in a direction of a first axis in comparison with a second axis perpendicular to the first axis.

10. The device according to claim 8, wherein:
the processing optical unit comprises a telescope system configured to introduce the laser beam with a reduced and/or increased size into the workpiece, and/or
the feed device comprises an axis device and a workpiece holder that are configured to move the processing optical unit and the workpiece relative to one another along three spatial axes in translational fashion and about at least two spatial axes in rotational fashion.

11. The device according to claim 8, wherein:
the work angle of the processing optical unit is between 0 and 60°, and/or component laser rays of the laser beam are incident on the workpiece at an angle of incidence of no more than 80° with respect to a surface normal of the workpiece.

12. The device according to claim 8, further comprising a polarization optical unit, the polarization optical unit comprising a polarizer and a waveplate, and configured to adjust a polarization of the laser beam relative to a plane of incidence of the laser beam.

13. The device according to claim 12, wherein the polarization optical unit is configured to adjust the polarization parallel to the plane of incidence of the laser beam.

14. The device according to claim 10, wherein the axis device is adjusted for aligning a long axis of the non-radially symmetric transverse intensity distribution along a feed direction.

15. The device according claim 8, further comprising:
a beam guiding device configured to guide the laser beam to the workpiece, the beam guiding device comprising a mirror system and/or an optical fibre, and/or
control electronics configured to trigger a laser pulse emission of the ultrashort pulse laser based on relative positions of the laser beam and the workpiece.

16. The device according to claim 10, wherein the workpiece holder has a surface that does not reflect and/or scatter the laser beam.
